(19) United States
(12) Patent Application Publication
(10) Pub. No.: US 2020/0048005 A1
(43) Pub. Date: Feb. 13, 2020

(54) MOBILE STORAGE AND RETRIEVAL SYSTEM

(71) Applicant: PaR Systems, LLC, Shoreview, MN (US)

(72) Inventors: Glen Kraetsch, Arden Hills, MN (US); Daniel Hagen, Cottage Grove, MN (US); Charles Ridley, Red Wing, MN (US)

(21) Appl. No.: 16/538,323

(22) Filed: Aug. 12, 2019

Related U.S. Application Data
(60) Provisional application No. 62/718,199, filed on Aug. 13, 2018.

(51) Int. Cl. B65G 1/137; G06Q 10/08

(52) U.S. Cl. CPC B65G 1/1375; G06Q 10/087; B65G 1/1378

(57) ABSTRACT

A mobile storage and retrieval system may include a storage facility configured to store a plurality of articles and dispense at least one article, a mobile storage transport configured to receive and autonomously transport the at least one article from the storage facility, and a dispensing kiosk configured to receive the at least one article from the mobile storage transport. The mobile storage transport may include a storage bin mounted on a mobile transport configured to contain at least one article and at least one locking cover. The mobile storage transport may also include at least one lifting device coupled to the storage bin which is configured to selectively open and close the at least one locking cover over at least one opening in the storage bin.

### CROSS-REFERENCE TO RELATED APPLICATION

The present application is based on and claims the benefit of U.S. provisional patent application Ser. No. 62/718,199, filed Aug. 13, 2018, the content of which is hereby incorporated by reference in its entirety.

### BACKGROUND

The present disclosure is related to mobile storage and retrieval systems.

Electro-mechanical systems are commonly used to store and retrieve articles. One well-known example of such a system is a kiosk. Kiosks generally serve the purpose of selling articles such as snacks, beverages, and newspapers. Article selection is commonly performed by selecting an item using a user interface. Commonly, kiosks are a single enclosure having a storage area for storing various articles, one or more mechanisms to move a selected article to a dispensing location of the enclosure, and an interface integrated in the enclosure. For example, the user interface may include push buttons or a touch screen that enable a user to choose a desired article. The enclosure also commonly includes a system for receiving payment for the selected article. Once an article is selected and the required payment has been received, the desired article is delivered to the dispensing area of the enclosure where the user may retrieve the article.

### SUMMARY

This Summary and Abstract are provided herein to introduce a selection of concepts in simplified form that are further described below in the Detailed Description. The Summary and Abstract are not intended to identify key features or essential features of the claimed subject matter, nor are they intended to be used as an aid in determining the scope of the claimed subject matter. The claimed subject matter is not limited to the implementations that solve any or all the disadvantages noted in the background.

Embodiments of the present disclosure are directed to robotic storage and retrieval systems. The systems may be used in applications such as, but not limited to, dispensing an article (e.g. a product) to a user. For example, in an embodiment, a system may have a user interface that allows for a user to query, review, and select an article. The article is then retrieved and dispensed to the user. Embodiments of the present disclosure are not however limited to any particular application and may be used in other settings.

In one particular implementation, a mobile storage and retrieval system includes a storage facility, such as a three-dimensional storage rack. The rack may include a plurality of rows and columns. At each unique row and column position, the rack may include at least one article. In one example, at each unique row and column position is located a set of article holders. Each set of article holders has one or more article holders, and each article holder optionally includes an article included within it. The storage facility is illustratively able to selectively retrieve and dispense any one of the articles included anywhere within the three-dimensional storage rack.

A mobile storage and retrieval system may also include a mobile storage transport, such as a mobile robotic device with a storage bin. The mobile storage transport may be configured to receive an article from the storage facility, store the article in the storage bin, and autonomously transport the article to a dispensing kiosk configured to receive the article. The dispensing kiosk may include a system for selecting an article, accepting payment for the article, and dispensing an article received from the mobile storage transport to a dispensing area where the user may retrieve the article.

In one embodiment, the mobile storage and retrieval system includes the storage facility configured to store a plurality of articles and dispense at least one article, and the mobile storage transport configured to receive and autonomously transport the at least one article from the storage facility. The mobile storage transport includes the storage bin mounted on a mobile transport configured to contain at least one article, at least one locking cover, and at least one lifting device coupled to the storage bin configured to selectively open and close the at least one locking cover over at least one opening in the storage bin. The system also includes the dispensing kiosk configured to receive the at least one article from the mobile storage transport.

Implementations may include one or more of the following features. The storage facility further including a slide configured to dispense the at least one article into the storage bin of the mobile storage transport; where the mobile storage transport is configured to receive the at least one article through the at least one opening in the storage bin; where the dispensing kiosk further includes a slide configured to receive the at least one article from the mobile storage transport; where the mobile storage transport is configured to cooperate with the storage facility by selectively unlocking and opening the at least one locking cover from the at least one opening in the storage bin; where the at least one locking cover is configured to remain locked when closed over the at least one opening in the storage bin; where the mobile transport is configured to cooperate with the dispensing kiosk by selectively unlocking and opening the at least one locking cover from the at least one opening in the storage bin; where the mobile storage transport includes a tiltable storage bin; where the mobile storage transport includes a fixed storage bin; where the storage bin includes an upper opening and a lower opening; where the storage bin is configured to receive the at least one article at an upper opening and dispense the at least one article at a lower opening; where the mobile storage transport further includes an article cushion; and where the mobile storage transport receives power from the mobile transport.

In another embodiment, a mobile storage and retrieval system includes a storage system mounted on a mobile robot configured to receive, store, and dispense an article. The storage system includes a storage bin and a locking cover configured to receive and securely store the article. The storage system further includes a lifting device configured to selectively open and close the locking cover over an opening in the storage bin.

Implementations may include one or more of the following features. The storage system can include a tiltable storage bin; where the tiltable storage bin is configured to rotationally tilt such that the article slides out of the tiltable storage bin; where the storage system includes a fixed storage bin; where the fixed storage bin is at a fixed tilted position including an upper opening and a lower opening; and where the fixed storage bin is configured such that the article slides out of the fixed storage bin when the lifting device opens the locking cover over the lower opening in the storage bin.

A method of the disclosure includes providing a secured storage system mounted on a mobile transport. The method also includes receiving an article at a storage facility by opening at least one locking cover of a secured storage bin. The method further includes transporting the article autonomously to a dispensing kiosk after closing and locking the at least one locking cover of the secured storage bin. Finally, the method includes dispensing the article at the dispensing kiosk by unlocking and opening at least one locking cover of the secured storage bin such that the article slides out of the secured storage bin into the dispensing kiosk.

If desired, dispensing the article can further comprise rotationally tilting the secured storage bin such that the article is removable from the secured storage bin into the dispensing kiosk.

### BRIEF DESCRIPTION OF THE DRAWINGS

FIG. 1A is a perspective view of a mobile storage and retrieval system according to an embodiment of the present disclosure.

FIG. 1B is a side elevational view of the embodiment of FIG. 1A.

FIG. 2A is a front perspective view of a mobile storage and retrieval system according to an embodiment of the present disclosure.

FIG. 2B is a side perspective view of the embodiment of FIG. 2A.

FIG. 3 is a perspective view of a mobile storage and retrieval system according to an embodiment of the present disclosure.

FIG. 4 is a flow diagram of a method according to an embodiment of the present disclosure.

### DETAILED DESCRIPTION

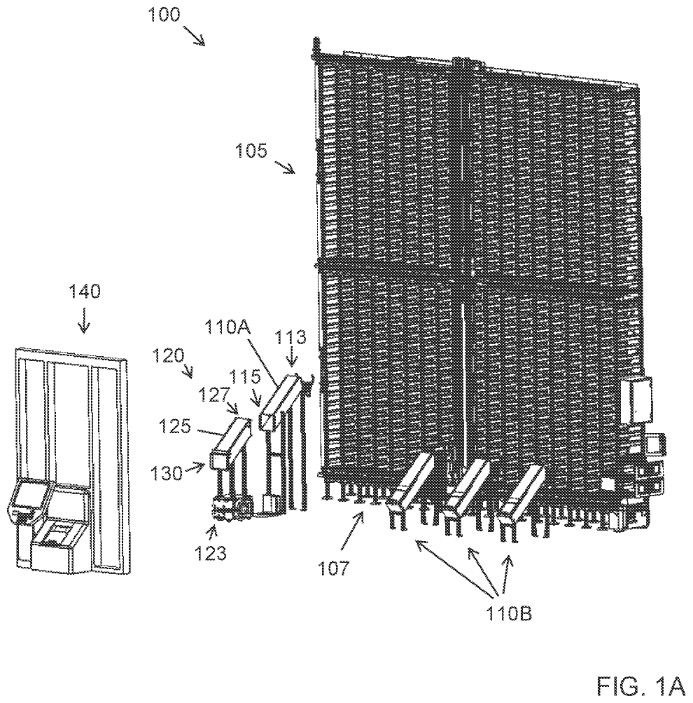

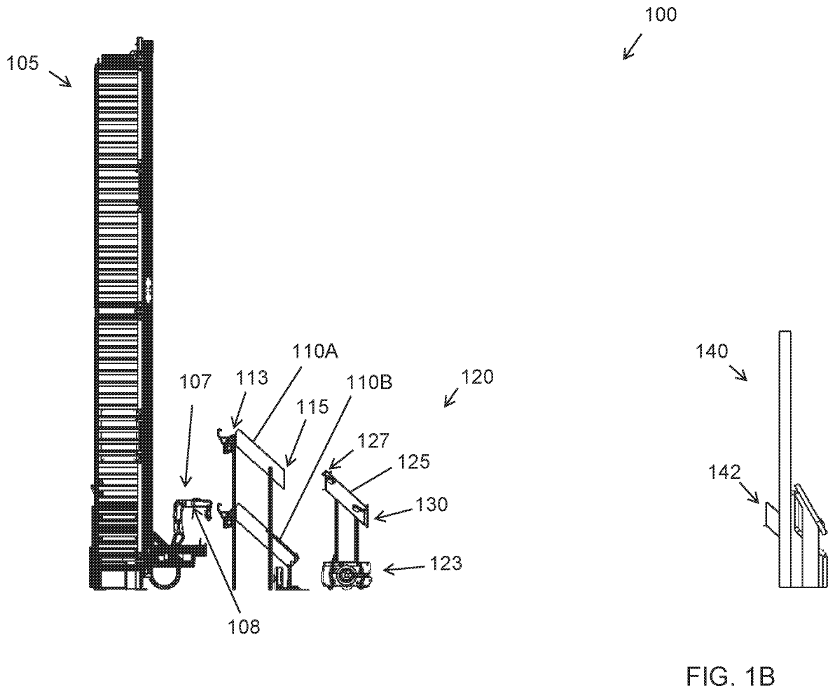

FIG. 1 is a perspective view of one embodiment of a mobile storage and retrieval system 100. System 100 includes a storage facility 105 (e.g., a three-dimensional storage rack), a mobile storage transport or storage transport 120 (e.g., a mobile robotic device with a storage bin), and a dispensing kiosk 140. Facility 105 may include storage locations organized based on a plurality of columns and a plurality of rows, and each unique row and column position may include an article. Embodiments are not limited to any particular number of rows and/or columns, and embodiments illustratively include any number of rows and/or columns, which may include any number of articles. One suitable storage facility 105 is described in U.S. Pat. No. 9,428,336 B2, which is hereby incorporated by reference in its entirety. Transport 120 includes a mobile transport 123 with a storage bin 125 configured to contain at least one article. The transport further includes a locking cover with a lifting device coupled to the storage bin 125 configured to selective open and close the locking cover over an opening in the storage bin to securely store the at least one article during transport from the storage facility 105 to the kiosk 140.

In an embodiment, articles within system 100 may include a product such as but not limited to, a compact disc, digital device, electrical cable/cord, a book, a video game disc, batteries, small commodities, etc.

Facility 105 may also include a robot 107, such as disclosed in U.S. Pat. No. 9,428,336 B2, configured such that it is able to store and/or retrieve articles to and from facility 105. In the embodiment shown in the figure, robot 107 moves among the plurality of columns and rows of facility 105 utilizing horizontal and vertical rails, which may remain stationary or movable, to position robot 107 at any particular number of rows and/or columns in facility 105.

Robot 107 further optionally includes an arm 108. Arm 108 is a multi-axes arm such as, but not limited to, a two to six axes arm. In one embodiment, arm 108 is configured to pick-up article holders or articles and then store the articles in the facility 105. Arm 108 may further be configured to retrieve articles from facility 105, and then drop-off the contents of the article holders at a dispensing station, such as a chute or slide 110A, 110B, or storage bin 125. It should be noted that various mechanisms besides the robot 107 can be used to transport the selected article from the storage facility 105 to slide 110A, 110B, or storage bin 125. The specific use of the robot 107 or arm 108 or the specific structure of robot 107 is not relevant to aspects of the present invention.

Dispensing slide 110A is configured to dispense at least one article to transport 120. In one embodiment, slide 110A is configured in a fixed tilted position with a top or upper opening and a bottom or lower opening. Slide 110A is configured such that an article may enter the top opening (e.g., by robot 107), slide down slide 110A, and exit the lower opening into a storage bin 125 of transport 120. Transport 120 is configured to receive at least one article from facility 105 in storage bin 125 and autonomously transport the article to a consumer dispensing station, e.g., dispensing kiosk 140.

Transport 120 is configured to cooperate with kiosk 140 to dispense the article into kiosk 140. In one example, dispensing kiosk 140 includes a receiver, for example, a chute or slide configured to receive an article (e.g., slide 142 of FIG. 1B) from the storage bin 125. Kiosk 140 may then dispense the article to a user. Embodiments of the present disclosure are not however limited to any particular configuration or type of consumer dispensing station or dispensing mechanism.

System 100 also optionally includes a user interface. The user interface may be implemented as a computer such as, but not limited to, a computer with a display and a keyboard and/or mouse, or a computer with a touch-screen display. In one example, the user interface may be located at kiosk 140. A user illustratively utilizes the user interface to query and review articles (e.g. products) that are available, and to select an article that is stored in facility 105. The user may also optionally utilize the user interface to pay for the article (e.g. by using cash or a credit card). The article is then retrieved at facility 105, transported by transport 120, and is dispensed to the user at kiosk 140.

Referring to FIGS. 1A and 1B, system 100 may include a plurality of slides configured to dispense an article to transport 120. As can be seen, chute or slide 110A is configured at a height that is greater than chute or slide 110B, and transport 120 includes storage bin 125 with a height configured to cooperate with slide 110A. When transport 120 is engaged with slide 110A, storage bin 125 of transport 120 may be configured to receive an article. Slide 110B illustrates that the slides can be at any suitable height to work with the specific transport used. Also, Storage facility 105 commonly includes one or more walls to prevent access into the storage facility. The slides 110B can provide controlled access apertures through a front wall (not shown). One or more slides 110B can also be used with kiosks, not shown, integrated in the wall(s) of the storage facility 105.

Referring back to slide 110A, an article or a plurality of articles may be dispensed from facility 105 (e.g., retrieved and dispensed by robot 107) into an upper opening 113 of slide 110A. The article may then slide down slide 110A and exit lower opening 115 of slide 110A into an upper opening 127 of storage bin 125, if the transport 120 has positioned itself so as to align storage bin 125 with slide 110A. If upper opening 127 comprises a door, screen or the like, transport 120 would operate the door so that the article can slide from slide 110A into storage bin 125. It should be noted slide 110A could include a door, screen or the like which allows the article to be deposited into the slide 110A and remain in the slide 110A until the transport 120 arrives in position to receive the article from the slide 110A. If desired, the robot 107 and storage bin 125 can be configured such that the article is deposited directly in the storage bin 125, for example, but not limited to depositing the article through an aperture in the storage bin 125 with or without a door.

With the article in the storage bin 125, transport 120 may then autonomously transport the article to kiosk 140 and kiosk 140 may cooperate with transport 120 to receive the article. Storage bin 125 may also include a lower opening 130 configured to dispense the article into kiosk 140. In one example, kiosk 140 includes a chute or slide 142 configured to receive the article from transport 120. Although slide 110A and slide 110B are shown with transport 120, this is for illustrative purposes only, and the number of slides and transports need not be so limited. One slide and transport or a plurality slides and a plurality of transports may be used. Further, the height of the slides 110A, 110B and storage bins 125 are displayed with different heights for illustrative purposes only, and storage bins may be configured with various heights to cooperate with different slides 110A, 110B of various heights.

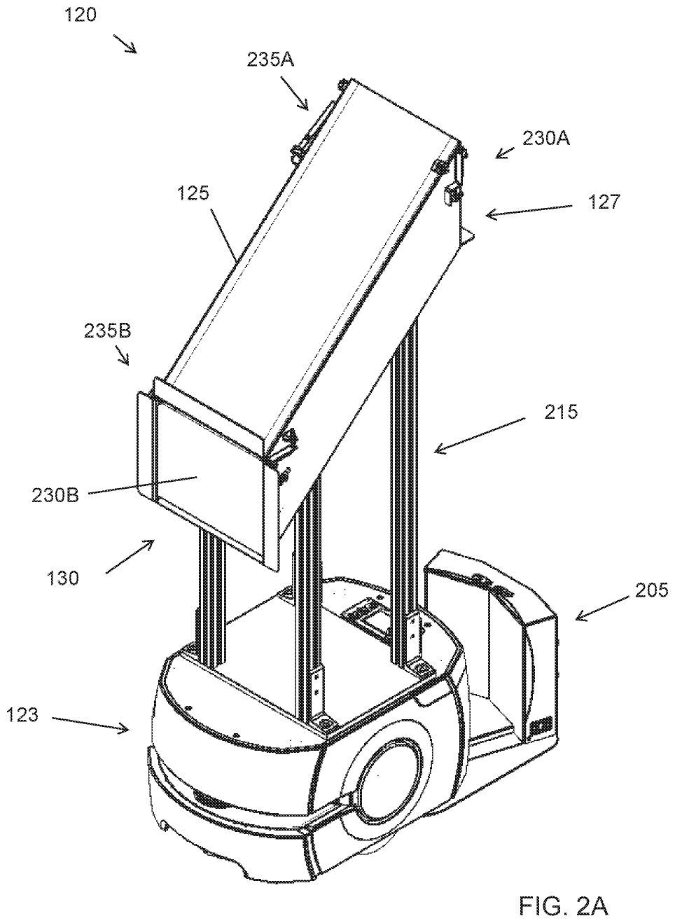

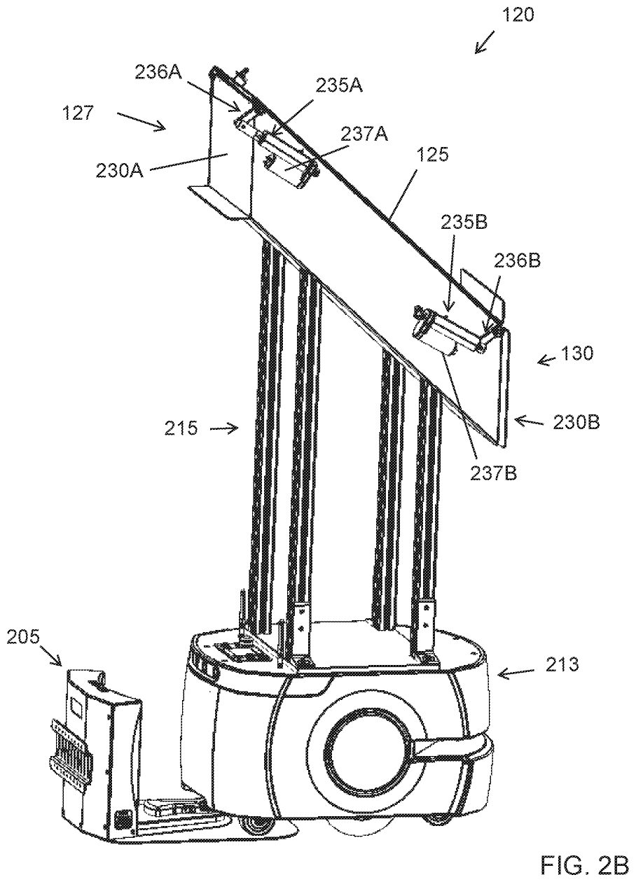

FIG. 2A is a perspective view of mobile storage transport 120 of FIGS. 1A and 1B. Storage transport 120 includes storage bin 125 mounted on mobile transport 123 (e.g., mobile robot) by supports 215. It should also be noted the height of the storage bin 125 can be adjustable automatically or manually to cooperate with different slides 110A, 110B of various heights. For instance, hydraulic, pneumatic or electric slides, ball screws or the like can be used to adjust supports 215. In the embodiment shown, storage bin 125 is mounted on mobile transport 123 at a fixed tilted position, e.g., as a fixed storage bin. Storage bin 125 includes openings 127, 130 with an upper opening 127 and a lower opening 130, such that upper opening 127 is at a higher elevation than a lower opening 130. Each opening 127, 130 is covered by a locking cover, screen or the like 230A, 230B, such that locking cover 230A covers upper opening 127 and locking cover 230B covers lower opening 130. Each locking cover 230A, 230B includes an actuating device, for example, an actuator assembly coupled to each associated locking cover 230A, 230B and the storage bin 125, which is configured to selectively open and close each respective locking cover 230A, 230B over each respective opening 127, 130.

Mobile transport 123 may be a mobile robot carriage configured to autonomously move through a variety of spaces and around various obstacles. Mobile transport 123 may include built-in sensors, cameras, and software, and may be configured to identify its surroundings and take an efficient route to its destination while avoiding obstacles, such as people, doorways, or entering and exiting elevators. Mission programming may be altered easily by networked devices, such as a smartphone, tablet or computer. A docking station 205 may also be provided for storage transport 120. Docking station 205 may engage with mobile transport 123 and provide power to charge mobile transport batteries. In one example, docking station 205 may be placed at a loading location, such as dispensing slide 110A of FIG. 1, such that mobile transport 123 is docked and charging at slide 110A when waiting to receive an article from facility 105.

FIG. 2B is perspective view of transport 120 from an opposite side from FIG. 2A. As can be seen in this embodiment, lower opening 130 of storage bin 125 is covered by locking cover 230B. Locking cover 230B is coupled to storage bin 125 and is further coupled to locking arm 235B that in turn is coupled to an actuator 237B. Similarly, locking cover 230A is coupled to storage bin 125 to cover upper opening 127 and is further coupled to locking arm 235A that in turn is coupled to an actuator 237A. Actuators 237A, 237B and associated locking arms 235A, 235B are configured to selectively open and close each respective locking cover 230A, 230B over openings 127, 130. The actuators 237A, 237B and locking arms 235A, 235B may be further configured to lock the locking covers 230A, 230B in a closed position, thereby inhibiting access into storage bin 125. Typically, locking covers 230A, 230B are configured to remain locked when closed when storage transport 120 is transporting between facility 105 and kiosk 140.

In the embodiment illustrated, each locking cover 230A, 230B is rotationally coupled to the storage bin 125, such that it may rotate from a closed position in an upward manner until it is an open position. For example, locking arm 235B may include a connecting rod to provide linear motion, e.g., a push and pull motion, to a lever 236B. The lever 236B, which is coupled to an axle of locking cover 230B, may convert the linear motion into rotational motion and rotate the locking cover 230B open or closed. Here, lower locking cover 230B is configured to open upward in an away or outward motion from storage bin 125 and is enabled to cooperate with a dispensing kiosk 140 so that the article therein slides into the receiver or slide 142 of the kiosk 140. Similarly, locking arm 235A may include a connecting rod to provide linear motion, e.g., a push and pull motion, to a lever 236A. The lever being coupled to an axle of locking cover 230A to convert the linear motion into rotational motion and rotate the locking cover 230A open or closed. Here, upper locking cover 230A is configured to open upward and inward, such that it rotates into storage bin 125 when in an open position and is configured to cooperate with the storage facility 105 to receive an article, such as by slide 110A of facility 105. In another embodiment, the cover 230A may rotate downwardly allowing, for example, the robot 107 to place the article within the storage bin 125 through the opening or possibly partially or fully on the cover 230A, which when moved to a closed position moves the article within the storage bin 125.

Although locking arms 235A, 235B are shown as a rod and lever converting linear motion to rotational motion to open and close locking covers 230A, 230B, the mechanism need not be so limited. Locking arms 235A, 235B may open and close locking covers 230A, 230B by various devices, such as but not limited to, motors, actuators (e.g., hydraulic, pneumatic, or electric). Although locking covers 230A, 230B are illustrated as single plates, one or both may comprise multiple plates hinged together or hinged separately from each other with separate actuator assemblies controlling each plate or a single actuator assembly and linkage controlling each plate. Although illustrated as rotatable cover doors, linearly operated doors can be used. Likewise, covers that rollup to expose the opening and extend to cover the opening can also be used. In one example, power for the actuators is provided from batteries of mobile transport 123.

Storage bin 125 is configured in a fixed tilted position such that an article may slide out of the storage bin 125 when the lower locking arm 235B lifts lower locking cover 230B and opens the locking cover 230B from lower opening 130. For example, when storage transport 120 arrives at a dispensing point (e.g., such as slide 142 of kiosk 140) with an article stored in storage bin 125, transport 120 may align opening 130 with a corresponding opening of slide 142. Transport 120 may then open locking cover 230B to uncover opening 130. Due to the tilted position of storage bin 125, the stored article may slide out of storage bin 125 into the corresponding slide 142 of kiosk 140. Once an article has been dispensed from transport 120, locking arm 235B may close and lock locking cover 230B over opening 130.

An article cushion may also be provided in various configurations in the storage facility (e.g., slides 110A, 110B of facility 105), mobile storage transport (e.g., transport 120), or consumer dispensing station (e.g., slide 142 of kiosk 140) to protect articles from damage, such as by shocks or vibrations, when receiving, transporting or dispensing an article. For example, storage transport 120 may include an article cushion configured inside storage bin 125 to protect articles from damage, such as when receiving an article from slide 110A, during transport, or when dispensing at kiosk 140. In one example, the article cushion may be provided on an interior side of locking cover 230B, such that when an article enters storage bin 125 through upper opening 127 and slides down storage bin 125 (e.g., due to the fixed tilted position of storage bin 125), the article is cushioned when stopped by lower locking cover 230B. Note, when transport 120 is receiving an article from slide 110A (e.g., the upper locking cover 230A is in an open position), the lower locking cover 230B remains closed and locked to contain the article. Similarly, when transport 120 is dispensing an article at kiosk 140 (e.g., the lower locking cover 230B is in an open position), the upper locking cover 230A may remain closed.

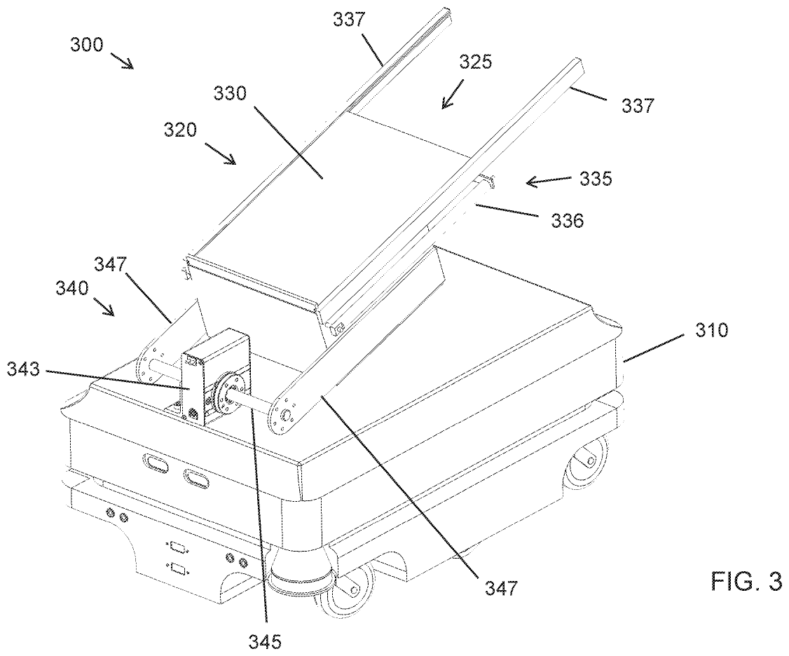

FIG. 3 is a perspective view of a mobile storage transport 300 including a tiltable storage bin 320 according to an embodiment of the present disclosure. Similar to mobile storage transport 120 of FIGS. 1 and 2 respectively, storage transport 300 is configured to receive and autonomously transport an article from a storage facility (e.g., facility 105) to a dispensing kiosk (e.g., kiosk 140) and includes the storage bin 320 mounted on a mobile robot or mobile transport 310. Mobile transport 310 is similar to mobile transport 123 described herein. Transport 300 includes a locking cover 330 which covers an opening 325 (not seen due to the locking cover 330 being closed) in the storage bin 320 and a lifting device or locking arm 335 coupled to the storage bin 320 and locking cover 330.

Lifting device or locking arm 335 is generally similar to locking arms 235A, 235B of FIG. 2 and is configured to selectively open and close the locking cover 330 over the opening 325 of the storage bin 320. The locking arm 335 may be further configured to lock the locking cover 330 in a closed position. For example, locking cover 330 is typically configured to remain locked when closed over opening 325 when mobile transport 300 is transporting between facility 105 and kiosk 140.

Locking arm 335 may open and close locking cover 330 by various devices, such as but not limited to, motors, actuators (e.g., hydraulic, pneumatic, or electric). Locking arm 335 may receive power from batteries of mobile transport 310. In the example illustrated in FIG. 3, locking arm 335 includes an actuator 336 to slide the locking cover 330 along a rail 337 to open and close locking cover 330 over opening 325 in storage bin 320. For example, when transport 300 is to receive an article (e.g., by slide 110A or 110B from facility 105), locking arm 335 may open the locking cover 330 by sliding locking cover 330 along rail 337 and uncovering opening 325. Once transport 300 has received an article, the locking cover 330 may return to a closed position guided by rail 337 so as to cover the opening 325.

The embodiment of FIG. 3 further includes a tilting device 340 coupled to storage bin 320 and mobile transport 310. Tilting device 340 is configured to rotationally tilt storage bin 320 from a first position (e.g., a horizontal position) to a second position (e.g., a tilted or substantially vertical position), such that an article stored in storage bin 320 can be accessed and removed from the storage bin 320 when in the tilted position. Tilting device 340 may tilt storage bin 320 by various devices, such as, but not limited to, motors, actuators (e.g., hydraulic, pneumatic, or electric) or electric linear motors. For example, in the illustration of FIG. 3, tilting device 340 includes a motor 343, an axle 345. Also included are arms 347 which connect storage bin 320 to axle 345. Motor 343 is coupled to mobile transport 310 and is configured to rotate axle 345 such that when axle 345 is rotated, storage bin 320 may rotate up or down between the first position and the second position. Tilting device 340 may receive power from batteries of mobile transport 310.

Tilting device 340 enables transport 300 to cooperate with a dispensing station (e.g., slide 110A or 110B of facility 105) to receive a package. For example, tilting device 340 enables transport 300 to align storage bin 320 with the dispensing station to receive an article. When receiving an article from a dispensing station, transport 300 may open locking cover 330 to uncover opening 325 and tilt storage bin 320 to a tilted position such that opening 325 is aligned with a corresponding opening in the dispensing station (e.g., the lower opening in slide 110A or 110B). Once an article is stored in storage bin 320, locking arm 335 may close and lock locking cover 330 over opening 325 and tilting device 340 may return storage bin 320 to a first or horizontal position.

Tilting device also enables transport 300 to cooperate with a delivery station (e.g., slide 142 of kiosk 140) to dispense the article into kiosk 140. For example, when transport 300 arrives at a dispensing point, such as slide 142 of kiosk 140, transport 300 may open locking cover 330 to uncover opening 325 and tilt storage bin 320 to a tilted position such that opening 325 is aligned with a corresponding opening of slide 142. Storage bin 320 is configured to dispense a stored article when it reaches a tilted position, such that the stored article may slide out of storage bin 320 into corresponding slide 142 of kiosk 140 (if tilted far enough such that the article is dispensed from the storage bin 320). Alternatively, the storage bin 320 is tilted so as to align with an opening at the kiosk 140, allowing the user to reach inside to the storage bin 320 through the opening in the kiosk 140 to retrieve the article. Once an article is no longer in the storage bin 320, locking arm 335 may close and lock locking cover 330 over opening 325 before, during or after the tilting device 340 returns storage bin 320 to the first or horizontal position.

Transport 300 may also include an article cushion inside storage bin 320 to protect articles from damage, such as when receiving an article from slide 110A or 110B, during transport, or when dispensing at kiosk 140. Further, article cushioning may be provided in various configurations in the storage facility (e.g., slides 110A, 110B of facility 105), mobile storage transport (e.g., transport 300), or consumer dispensing station (e.g., slide 142 of kiosk 140) to protect articles from damage, such as by shocks or vibrations, when receiving, transporting or dispensing an article.

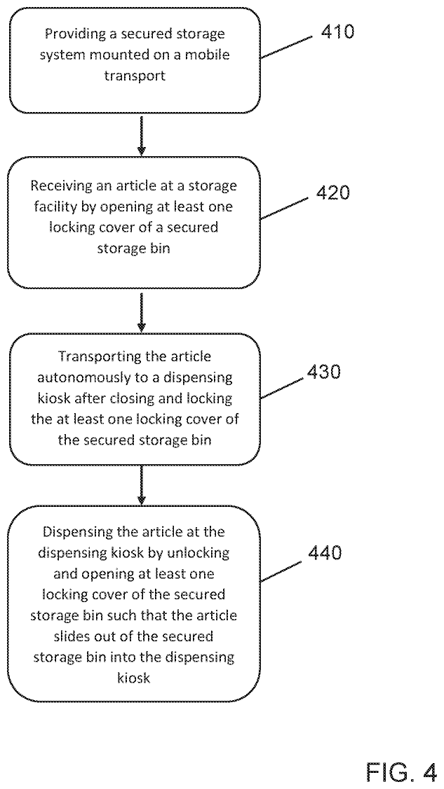

FIG. 4 is a flow diagram of a method for a mobile storage and retrieval system. It should be understood however that not all steps or portions of steps may be necessary, and thus should not be considered limiting. Likewise, the order of the steps may be changed. The exemplary method starts at step 410 which includes providing a secured storage system mounted on a mobile transport. Next, step 420 includes receiving an article at a storage facility by opening at least one locking cover of a secured storage bin. Next, step 430 includes transporting the article autonomously to a dispensing kiosk after closing and locking the at least one locking cover of the secured storage bin. Lastly, step 440 provides dispensing the article at the dispensing kiosk by unlocking and opening at least one locking cover of the secured storage bin such that the article is removed or slides out of the secured storage bin into the dispensing kiosk.

Aspects of the mobile storage and retrieval system as disclosed herein can provide one or more advantages. The mobile storage and retrieval system, such as system 100, enables articles stored inside a building or facility to be dispensed at an exterior of the building. For example, in system 100 of FIG. 1, the dispensing station (e.g., facility 105) may be provided in an interior of a building, such as a warehouse or consumer building, and a consumer dispensing station (e.g., kiosk 140) may be located a distance from the dispensing station, such as a different room or an exterior wall of the building. A mobile storage transport (e.g., transport 120) may be used to transfer an article (e.g., a product) to the dispensing station (e.g., kiosk 140) for a user. Benefits include reducing the space required by the system, such as by removing long chutes or conveyers to transport articles. The system also allows users (e.g., customers) to see and or interact with the system without interfering with article transportation. For example, a user may select an article or a plurality of articles (e.g., by a user interface at kiosk 140) and then view the selected article as it is located by facility 105 and dispensed into a storage bin (e.g., storage bin 125) of a mobile storage transport. The transport may then lock the article(s) securely in the storage bin to prevent tampering, and autonomously transport the article(s) to a dispensing area (e.g., kiosk 140) while avoiding obstacles, including humans, in its path. A chute or slide (e.g., slide 142) may be used to dispense the product to a user. For, example, slide 142 may penetrate the wall the kiosk is located in, which allows the article(s) to slide down to the kiosk but prevents the user from reaching in. The article(s) may then be dispensed to the user and the transport may autonomously return to a docking station and or dispensing station to repeat the operation.

Although various embodiments and examples have been illustrated and described herein, this disclosure is illustrative only, and changes may be made in detail in matters of structure, arrangement, and methods without departing from the scope of the present disclosure.

What is claimed is:

1. A mobile storage and retrieval system comprising:
a storage facility configured to store a plurality of articles and dispense at least one article;
a mobile storage transport configured to receive and autonomously transport the at least one article from the storage facility, the mobile storage transport comprising:
a storage bin mounted on a mobile transport configured to contain at least one article;
at least one locking cover; and
at least one lifting device coupled to the storage bin configured to selectively open and close the at least one locking cover over at least one opening in the storage bin; and
a dispensing kiosk configured to receive the at least one article from the mobile storage transport.

2. The system of claim 1, the storage facility further comprising a slide configured to dispense the at least one article into the storage bin of the mobile storage transport.

3. The system of claim 1, and wherein the mobile storage transport is configured to receive the at least one article through the at least one opening in the storage bin.

4. The system of claim 3, and wherein the dispensing kiosk further comprises a slide configured to receive the at least one article from the mobile storage transport.

5. The system of claim 1, and wherein the mobile storage transport is configured to cooperate with the storage facility by selectively unlocking and opening the at least one locking cover from the at least one opening in the storage bin.

6. The system of claim 1, and wherein the at least one locking cover is configured to remain locked when closed over the at least one opening in the storage bin.

7. The system of claim 1, and wherein the mobile transport is configured to cooperate with the dispensing kiosk by selectively unlocking and opening the at least one locking cover from the at least one opening in the storage bin.

8. The system of claim 1, and wherein the mobile storage transport comprises a tiltable storage bin.

9. The system of claim 1, and wherein the mobile storage transport comprises a fixed storage bin.

10. The system of claim 9, and wherein the storage bin comprises an upper opening and a lower opening.

11. The system of claim 10, wherein the storage bin is configured to receive the at least one article at an upper opening and dispense the at least one article at a lower opening.

12. The system of claim 1, and wherein the mobile storage transport further comprises an article cushion.

13. The system of claim 1, and wherein the mobile storage transport receives power from the mobile transport.

14. A mobile storage and retrieval system comprising:
a storage system mounted on a mobile robot configured to receive, store, and dispense an article, the storage system further comprising:
a storage bin and a locking cover configured to receive and securely store the article; and
a lifting device configured to selectively open and close the locking cover over an opening in the storage bin.

15. The system of claim 14, and wherein the storage system comprises a tiltable storage bin.

16. The system of claim 15, and wherein the tiltable storage bin is configured to rotationally tilt such that the article slides out of the tiltable storage bin.

17. The system of claim 14, and wherein the storage system comprises a fixed storage bin.

18. The system of claim 17, and wherein the fixed storage bin is at a fixed tilted position comprising an upper opening and a lower opening.

19. The system of claim 18, and wherein the fixed storage bin is configured such that the article slides out of the fixed storage bin when the lifting device opens the locking cover over the lower opening in the storage bin.

20. A method comprising:
providing a secured storage system mounted on a mobile transport;
receiving an article at a storage facility by opening at least one locking cover of a secured storage bin;
transporting the article autonomously to a dispensing kiosk after closing and locking the at least one locking cover of the secured storage bin; and
dispensing the article at the dispensing kiosk by unlocking and opening at least one locking cover of the secured storage bin such that the article slides out of the secured storage bin into the dispensing kiosk.

21. The method of claim 20, and wherein dispensing the article further comprises rotationally tilting the secured storage bin such that the article is removable from the secured storage bin into the dispensing kiosk.
